(19) United States
(12) Patent Application Publication
(10) Pub. No.: US 2026/0174278 A1
(43) Pub. Date: Jun. 25, 2026

(54) CAMPFIRE GRILL APPARATUS

(71) Applicant: Terry Bernarde, Omro, WI (US)

(72) Inventor: Terry Bernarde, Omro, WI (US)

(21) Appl. No.: 18/987,828

(22) Filed: Dec. 19, 2024

(51) Int. Cl. A47J 33/00; A47J 36/24

(52) U.S. Cl. CPC A47J 33/00; A47J 36/24

(57) ABSTRACT

A campfire grill apparatus for cooking food over a fire pit includes a cooking platform with an upper surface for supporting the food. A plurality of legs is coupled to and extends downwardly from the cooking platform. The legs are shaped and configured to rest atop a ground surface to support the cooking platform over a fire pit. The legs are also positioned and configured to be arranged around the fire pit. A warming shelf is coupled to and spaced above the cooking platform. The warming shelf has a top surface for supporting the food. An area of the top surface of the warming shelf is smaller than an area of the upper surface of the cooking platform. A support post is coupled to and extends between the cooking platform and the warming shelf.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to cooking grill apparatuses and more particularly pertains to a new cooking grill apparatus for cooking food over a fire pit.

### (2) Description of Related Art Including Information Disclosed Under 37 CFR 1.97 and 1.98

The prior art discloses myriad grill apparatuses for cooking food over a campfire, fire pit, or similar heat source. However, the prior art fails to describe such an apparatus which combines a perforated grill platform with a griddle and includes a warming shelf spaced above the perforated grill and griddle such that less heat reaches the warming shelf.

### (h) BRIEF SUMMARY OF THE INVENTION

An embodiment of the disclosure meets the needs presented above by generally comprising a cooking platform with an upper surface for supporting food. A plurality of legs is coupled to and extends downwardly from the cooking platform. The legs are shaped and configured to rest atop a ground surface to support the cooking platform over a fire pit. The legs are also positioned and configured to be arranged around the fire pit. A warming shelf is coupled to and spaced above the cooking platform. The warming shelf has a top surface for supporting the food. An area of the top surface of the warming shelf is smaller than an area of the upper surface of the cooking platform. A support post is coupled to and extends between the cooking platform and the warming shelf.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a campfire grill apparatus according to an embodiment of the disclosure.

FIG. 2 is a side view of an embodiment of the disclosure.

FIG. 3 is a top view of an embodiment of the disclosure.

FIG. 4 is an in-use view of an embodiment of the disclosure.

FIG. 5 is a top perspective view of an embodiment of the disclosure.

### (j) DETAILED DESCRIPTION OF THE INVENTION

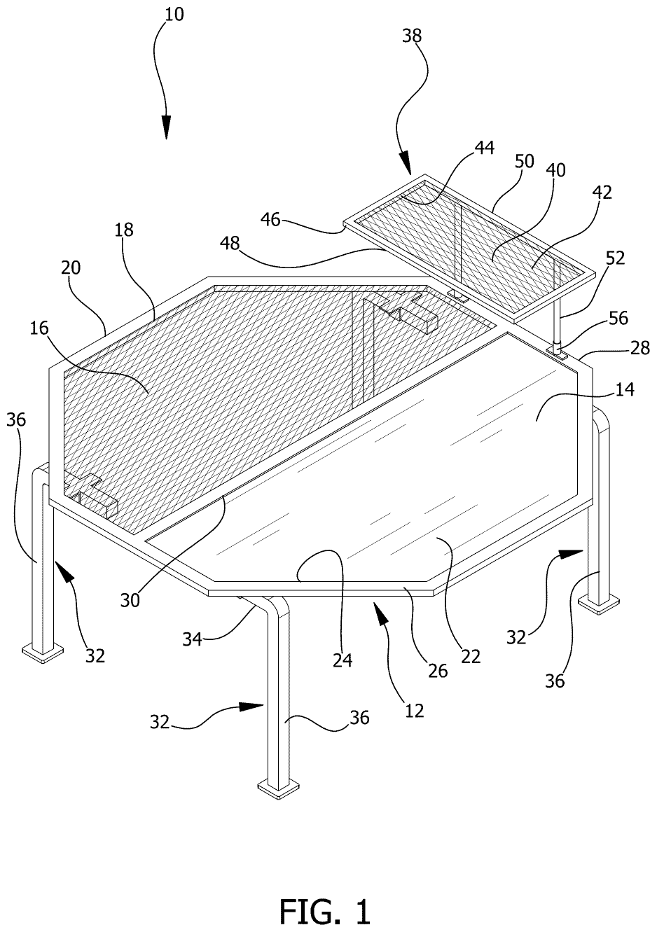

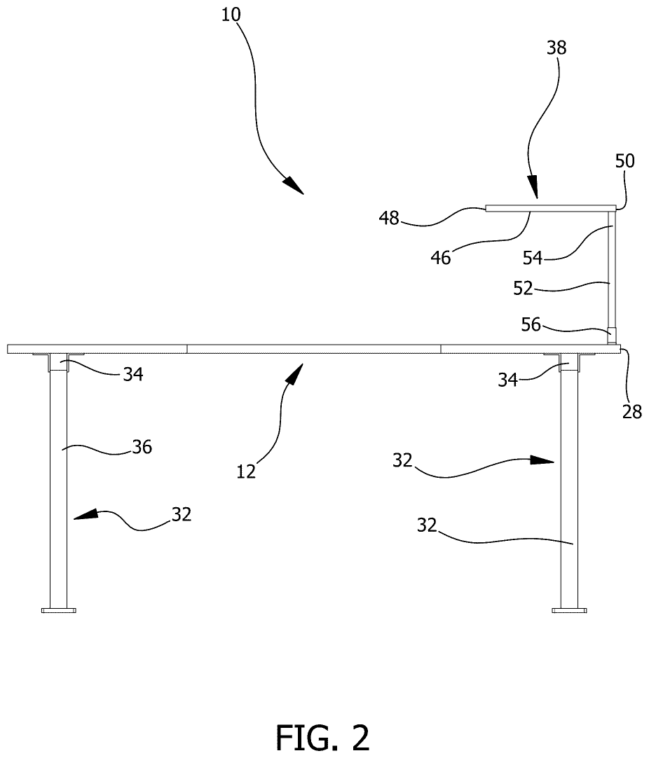

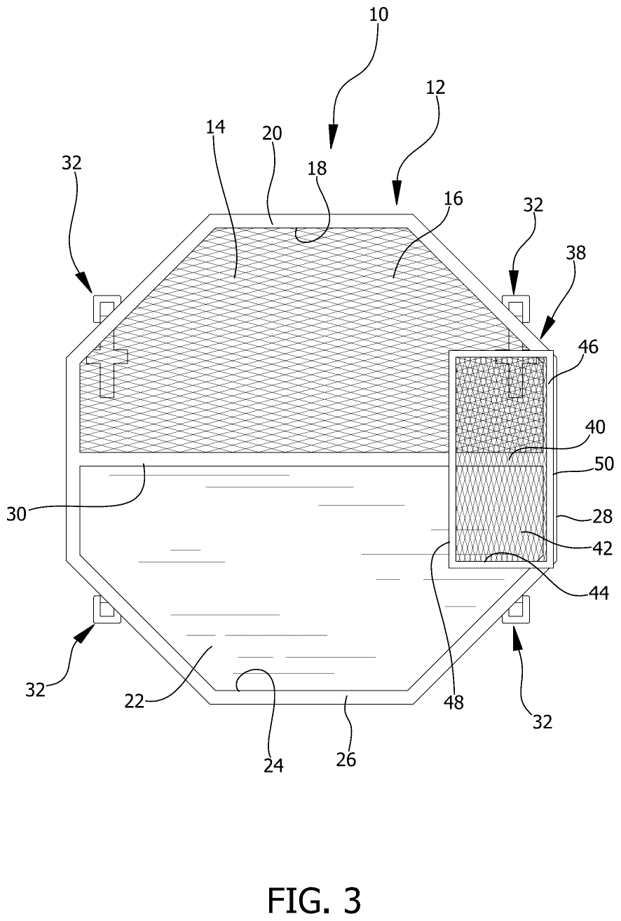

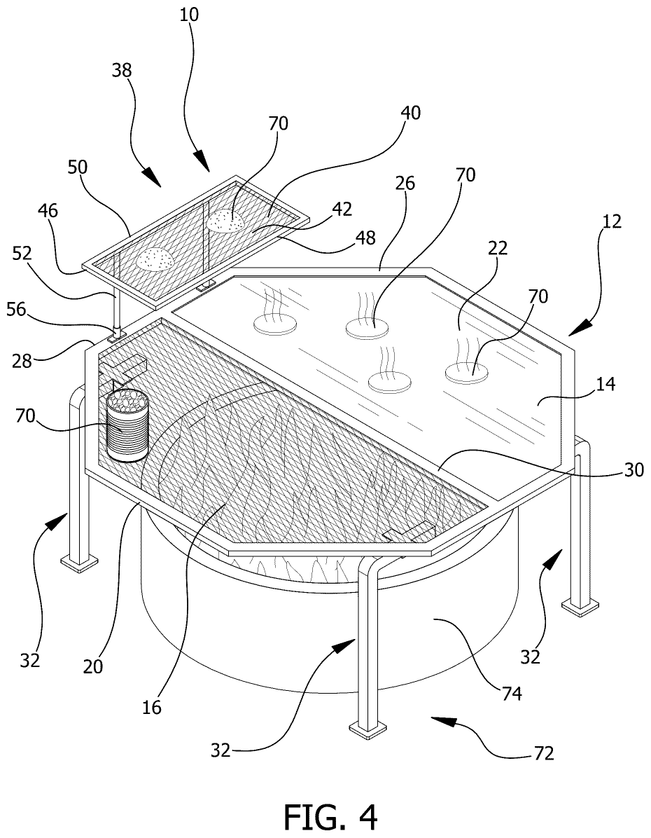

With reference now to the drawings, and in particular to FIGS. 1 through 5 thereof, a new cooking grill apparatus embodying the principles and concepts of an embodiment of the disclosure and generally designated by the reference numeral 10 will be described.

As best illustrated in FIGS. 1 through 5, the campfire grill apparatus 10 generally comprises a cooking platform 12 which has an upper surface 14 for supporting food 70. The cooking platform 12 comprises a cooking grill 16 which comprises a mesh screen material. The mesh screen material may be an expanded metal, weaved grating, welded grating, or the like. The cooking platform 12 further comprises a cooking grill frame 20 which is coupled to and extends around a perimeter 18 of the cooking grill 16.

A plurality of legs 32 is coupled to and extends downwardly from the cooking platform 12. Each leg 32 is shaped and configured to rest atop a ground surface 72 to support the cooking platform 12 over a fire pit 74. The legs 32 are also positioned and configured to be arranged around the fire pit 74. Each leg 32 has an L-shape with a horizontal portion 34 and a vertical portion 36. The horizontal portion 34 is coupled to and extends horizontally outwardly from the cooking platform 12. The vertical portion 36 is coupled to a distal end of the horizontal portion 34 with respect to the cooking platform 12 and extends downwardly from the horizontal portion 34.

A warming shelf 38 is coupled to and spaced above the cooking platform 12. The warming shelf 38 has a top surface 40 for supporting the food 70. An area of the top surface 40 of the warming shelf 38 is smaller than an area of the upper surface 14 of the cooking platform 12. The warming shelf 38 comprises a warming grill 42 which comprises the mesh screen material. The warming shelf 38 further comprises a warming grill frame 46 frame which is coupled to and extends around a periphery 44 of the warming grill 42. A pair of support posts 52 is coupled to and extends between the cooking platform 12 and the warming shelf 38. A bottom end 56 of each support post 52 is positioned adjacent to a rear end 28 of the cooking platform 12.

In an embodiment shown in FIGS. 1 through 4, the cooking platform 12 further comprises a griddle 22 which comprises an unperforated planar material such as sheet metal, plate metal, or the like. The griddle 22 and the cooking grill 16 are positioned laterally from each other with respect to the cooking platform 12. The cooking platform 12 further comprises a griddle frame 26 which is coupled to and extends around an outer edge 24 of the griddle 22. The griddle frame 26 and the cooking grill frame 20 define a divider 30 between the griddle 22 and the cooking grill 16. The griddle frame 26 and the cooking grill 16 are integrally formed with each other along the divider 30. A top end 54 of each support post 52 is positioned adjacent to a back end 50 of the warming shelf 38, and the warming shelf 38 extends over the cooking platform 12 from the pair of support posts 52.

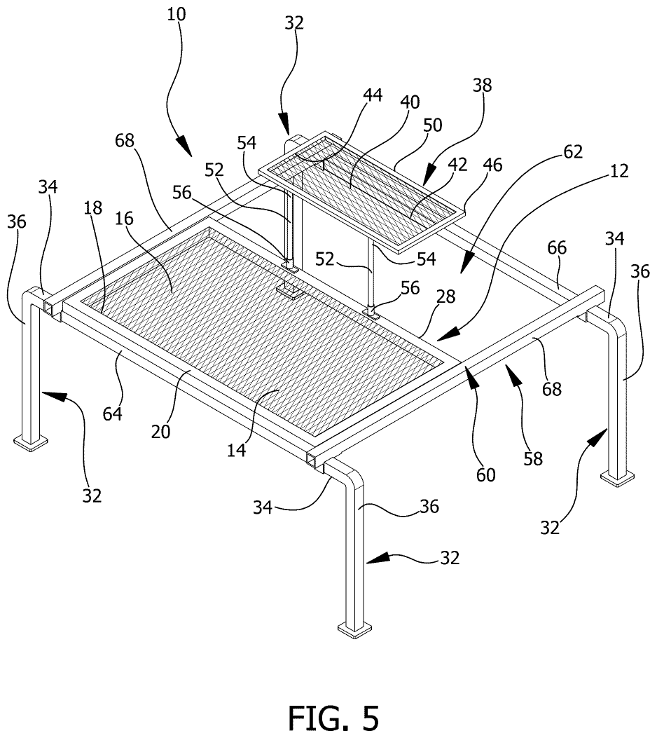

With reference to FIG. 5, another embodiment of the disclosure further includes a support frame 58 which couples the cooking platform 12 to the plurality of legs 32. The support frame 58 defines an aperture 60 which extends through the support frame 58, and the cooking platform 12 is positioned in the aperture 60 adjacent to a front portion 64 of the support frame 58. The cooking platform 12 is spaced from a rear portion 66 of the support frame 58 to form a gap 62 between the cooking platform 12 and the rear portion 66 of the support frame 58. The cooking platform 12 extends across an entire width of the aperture 60 between a pair of lateral portions 68 of the support frame 58. A top end 54 of each support post 52 is positioned adjacent to a front end 48 of the warming shelf 38, and the warming shelf 38 extends from the pair of support posts 52 over the gap 62 between the cooking platform 12 and the rear portion 66 of the support frame 58.

In use, the campfire grill apparatus 10 is positioned over the fire pit 74. The legs 32 raise the cooking platform 12 such that it does not interfere with the fire pit 74 or the contents thereof. The legs 32 are also arranged to give support all around the fire pit 74 for the cooking platform 12. In the case of the embodiment shown in FIGS. 1 through 4, different surfaces may be chosen for cooking food 70. Food 70 may be cooked on the cooking grill 16 or the griddle 22. Different food 70s may be placed on these different surfaces. The warming shelf 38 is spaced above the cooking platform 12 such that less heat reaches the warming shelf 38 from the fire pit 74 than reaches the cooking platform 12. The warming shelf 38 may thus be used to heat or warm food items which are prone to burning or over-cooking. For example, hamburger buns may be warmed on the warming shelf 38 while burger patties are cooked on the cooking platform 12.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A campfire grill apparatus comprising:
a cooking platform having an upper surface wherein the cooking platform is configured to support food on the upper surface;
a plurality of legs coupled to and extending downwardly from the cooking platform, the plurality of legs being shaped and configured to rest atop a ground surface to support the cooking platform over a fire pit, the plurality of legs being positioned and configured to be arranged around the fire pit;
a warming shelf coupled to and spaced above the cooking platform, the warming shelf having a top surface wherein the warming shelf is configured to support the food on the top surface, an area of the top surface of the warming shelf being smaller than an area of the upper surface of the cooking platform; and
a support post coupled to and extending between the cooking platform and the warming shelf.

2. The campfire grill apparatus of claim 1, wherein the cooking platform comprises a cooking grill, the cooking grill comprising a mesh screen material.

3. The campfire grill apparatus of claim 2, wherein the cooking platform further comprises a cooking grill frame which is coupled to and extends around a perimeter of the cooking grill.

4. The campfire grill apparatus of claim 1, wherein each leg of the plurality of legs having an L-shape with a horizontal portion and a vertical portion, the horizontal portion being coupled to and extending horizontally outwardly from the cooking platform, the vertical portion being coupled to a distal end of the horizontal portion with respect to the cooking platform and extending downwardly from the horizontal portion.

5. The campfire grill apparatus of claim 1, wherein the warming shelf comprises a warming grill, the warming grill comprising a mesh screen material.

6. The campfire grill apparatus of claim 5, wherein the warming shelf further comprises a warming grill frame which is coupled to and extends around a periphery of the warming grill.

7. The campfire grill apparatus of claim 1, wherein the cooking platform comprises a cooking grill and a griddle, the cooking grill comprising a mesh screen material, the griddle comprising an unperforated planar material, the griddle and the cooking grill being positioned laterally from each other with respect to the cooking platform.

8. The campfire grill apparatus of claim 7, wherein the cooking platform further comprises a cooking grill frame which is coupled to and extends around a perimeter of the cooking grill, the cooking platform further comprising a griddle frame which is coupled to and extends around an outer edge of the griddle, the griddle frame and the cooking grill frame defining a divider between the griddle and the cooking grill, the griddle frame and the cooking grill being integrally formed along the divider.

9. The campfire grill apparatus of claim 1, wherein a bottom end of the support post is positioned adjacent to a rear end of the cooking platform, a top end of the support post being positioned adjacent to a back end of the warming shelf, the warming shelf extending over the cooking platform from the pair of support posts.

10. The campfire grill apparatus of claim 1, further comprising a support frame coupling the cooking platform to the plurality of legs, the support frame defining an aperture which extends through the support frame, the cooking platform being positioned in the aperture adjacent to a front portion of the support frame, the cooking platform being spaced from a rear portion of the support frame to form a gap between the cooking platform and the rear portion of the support frame.

11. The campfire grill apparatus of claim 10, wherein the cooking platform extends across an entire width of the aperture between a pair of lateral portions of the support frame.

12. The campfire grill apparatus of claim 10, wherein the warming shelf extends from the pair of support posts over the gap between the cooking platform and the rear portion of the support frame.

13. A campfire grill apparatus comprising:
a cooking platform having an upper surface wherein the cooking platform is configured to support food on the upper surface, the cooking platform comprising a cooking grill, the cooking grill comprising a mesh screen material, the cooking platform further comprising a cooking grill frame which is coupled to and extends around a perimeter of the cooking grill;
a plurality of legs coupled to and extending downwardly from the cooking platform, the plurality of legs being shaped and configured to rest atop a ground surface to support the cooking platform over a fire pit, the plurality of legs being positioned and configured to be arranged around the fire pit, each leg of the plurality of legs having an L-shape with a horizontal portion and a vertical portion, the horizontal portion being coupled to and extending horizontally outwardly from the cooking platform, the vertical portion being coupled to a distal end of the horizontal portion with respect to the cooking platform and extending downwardly from the horizontal portion;
a warming shelf coupled to and spaced above the cooking platform, the warming shelf having a top surface wherein the warming shelf is configured to support the food on the top surface, an area of the top surface of the warming shelf being smaller than an area of the upper surface of the cooking platform, the warming shelf comprising a warming grill, the warming grill comprising the mesh screen material, the warming shelf further comprising a warming grill frame which is coupled to and extends around a periphery of the warming grill; and
a pair of support posts coupled to and extending between the cooking platform and the warming shelf, a bottom end of each support post of the pair of support posts being positioned adjacent to a rear end of the cooking platform.

14. The campfire grill apparatus of claim 13, wherein:
the cooking platform further comprises a griddle, the griddle comprising an unperforated planar material, the griddle and the cooking grill being positioned laterally from each other with respect to the cooking platform, the cooking platform further comprising a griddle frame which is coupled to and extends around an outer edge of the griddle, the griddle frame and the cooking grill frame defining a divider between the griddle and the cooking grill, the griddle frame and the cooking grill being integrally formed along the divider; and
a top end of each support post of the pair of support posts being positioned adjacent to a back end of the warming shelf, the warming shelf extending over the cooking platform from the pair of support posts.

15. The campfire grill apparatus of claim 13, further comprising:
a support frame coupling the cooking platform to the plurality of legs, the support frame defining an aperture which extends through the support frame, the cooking platform being positioned in the aperture adjacent to a front portion of the support frame, the cooking platform being spaced from a rear portion of the support frame to form a gap between the cooking platform and the rear portion of the support frame, the cooking platform extending across an entire width of the aperture between a pair of lateral portions of the support frame; and
wherein a top end of each support post of the pair of support posts is positioned adjacent to a front end of the warming shelf, the warming shelf extending from the pair of support posts over the gap between the cooking platform and the rear portion of the support frame.
